(19) United States
(12) Patent Application Publication
(10) Pub. No.: US 2006/0014435 A1
(43) Pub. Date: Jan. 19, 2006

(54) Card connector

(75) Inventor: Hui-Wen Tsao, Taoyuan (TW)

Correspondence Address: TROXELL LAW OFFICE PLLC, Suite 1404, 5205 Leesburg Pike, Falls Church, VA, 22041, US

(73) Assignee: P-Two Industries Inc.

(21) Appl. No.: 10/890,101

(22) Filed: Jul. 14, 2004

(51) Int. Cl. H01R 24/00

(52) U.S. Cl. 439/630

(57) ABSTRACT

A card connector, especially an electronic card connector, is composed of an insulative body, a multiple number of conductive terminals, a bump and an auxiliary bump. The insulative body consists of a base with card slot and elastic arms sticking out at both sides of the base. A multiple number of conductive terminals are located on the card slot. The bump is formed on the inner side of the terminal of the elastic arm. The auxiliary bump is also formed on the inner side and located at the back of the bump. The present invention can effectively enhance card insertion stability and prevent the card from getting loosened. Besides, the present invention also facilitates the positioning of the electronic card while it is inserted into the slot.

### BACKGROUND OF THE INVENTION

1. Field of the Invention

The present invention is related to a “card connector”, especially a device into which an electronic card is inserted for electric connection to a circuit structure or a storage device.

2. Description of the Related Art

An electronic card (IC card or smart card) is a data input device that can be electrically connected to a circuit structure or a storage device, for example, a word processor, a computer or other circuit structure, so the data stored in the electronic card can be transmitted to the circuit structure. The electronic card is a portable device with a card connector for simple insertion and removal.

Please refer to figures from FIG. 1 to FIG. 4. A traditional card connector is composed of an insulative body 1′ and a multiple number of conductive terminal 2′ on the insulative body 1′. The insulative body 1′ consists of a base 11′ for a card slot 111′ and one elastic arm 12′ sticking out at each end of the base 11′. On the inner side 121′ of the terminal of each elastic arm 12′, there is a bump 13′ with a differentiated section 131′ in a shape that the top is larger than the bottom. When an electronic card 3′ is obliquely inserted into the card slot 111′ and further pressed down, the electronic card 3′ will be put between the base 11′ and the two elastic arms 12′, as in FIG. 2 and FIG. 4. The electronic card 3′ is positioned because its two sides are subject to pressing by the two bumps 13′. The side of the electronic card 3′ locks into the differentiated section 131′ of each bump 13′. Although the card connector has the above-described connecting and positioning function for an electronic card 3′, with reference to FIG. 2, either side of the electronic card 3′ only locks into a small portion of the bump 13′ and easily creates a loose connection. This type of connecting mechanism is susceptible to card detachment.

Further, the above-described card connector is subject to destructive testing. When the already positioned electronic card 3′ is in destructive testing, the card connector and the electronic card 3′ will certainly be separate. Therefore, the connecting mechanism for a traditional card connector needs to be improved because of the drawback of easy card detachment.

Further, although enlarged bump 13′ may provide better connecting effect, it also increases the difficulty in pressing down the inserted electronic card 3′.

### SUMMARY OF THE INVENTION

The inventor of the present invention has studied the card connector and proposed a reasonable design that can effectively improve the above-mentioned drawback for the traditional card connector.

The main objective of the present invention is to provide an effective connecting effect for a card connector with the ease of pressing down an electronic card.

To achieve the above purpose, the present invention provides a card connector that is composed of an insulative body and a multiple number of conductive terminals. The insulative body consists of a base with a card slot and two sticking elastic arms symmetrically located at both sides of the base. The inner side of the terminal of each elastic arm has a bump and an auxiliary bump. The multiple number of conductive terminals is in the card slot. The design effectively enhances the connection and prevents the card from easy detachment. It also facilitates the positioning of the electronic card while it is inserted into the slot.

### BRIEF DESCRIPTION OF THE DRAWINGS

FIG. 1 is a three-dimensional illustration for a traditional card connector.

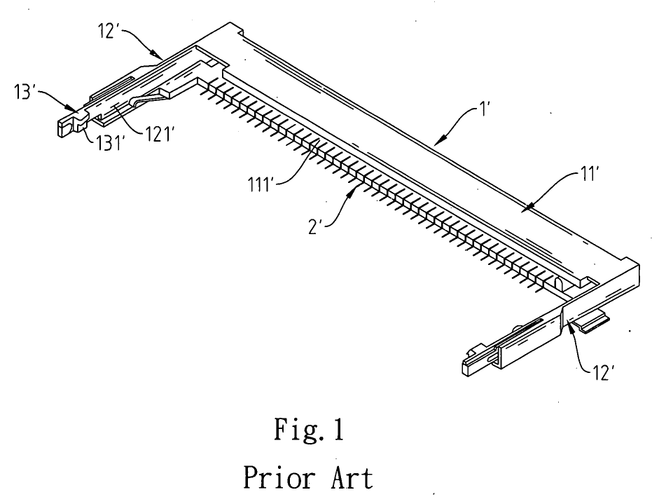

FIG. 2 is a partial top view for FIG. 1.

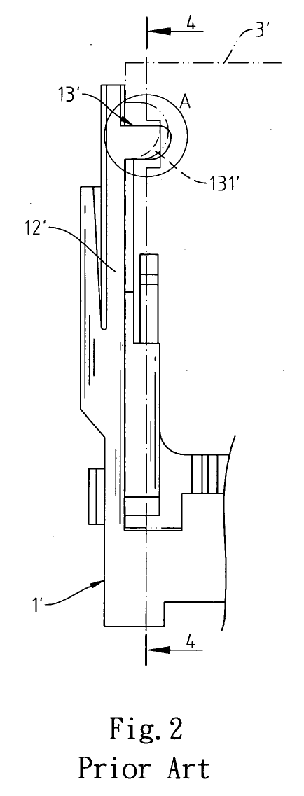

FIG. 3 is an enlarged view for A in FIG. 2.

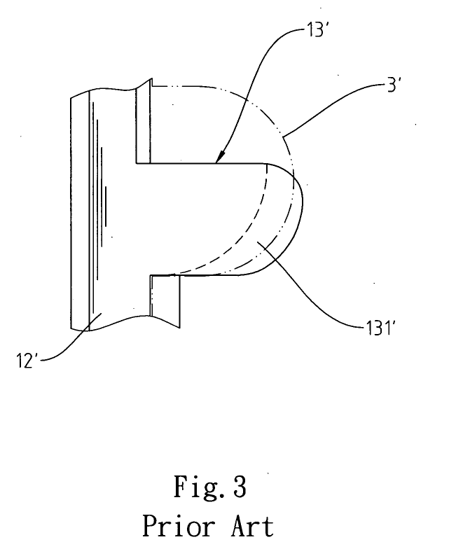

FIG. 4 is a cross sectional view for 4-4 in FIG. 2.

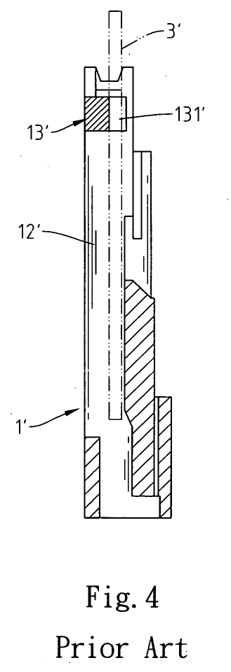

FIG. 5 is three-dimensional illustration for the present invention.

FIG. 6 is a partial top view for the present invention according to FIG. 5.

FIG. 7 is a partially enlarged view for A in FIG. 5.

FIG. 8 is a cross sectional view for 8-8 in FIG. 6.

### DETAILED DESCRIPTION OF THE INVENTION

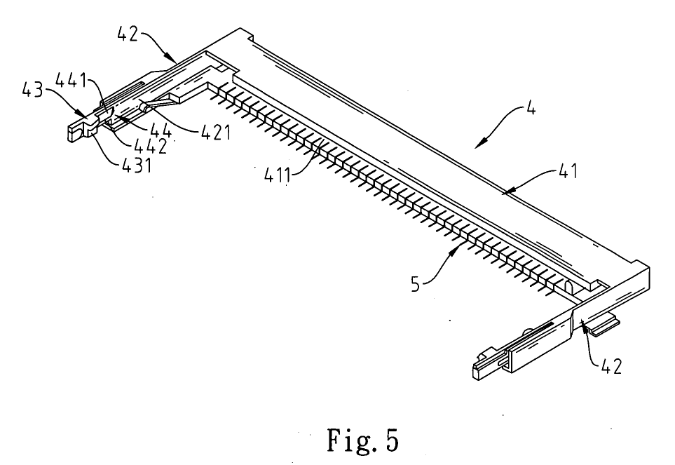

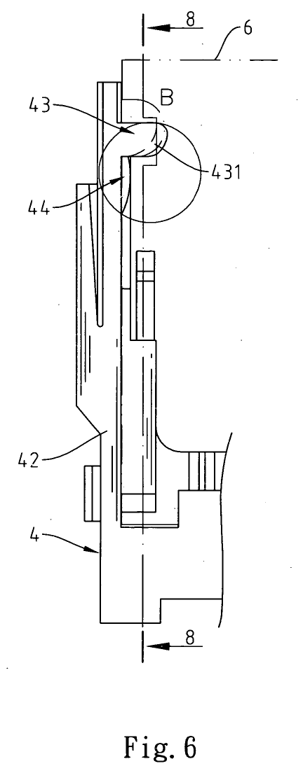

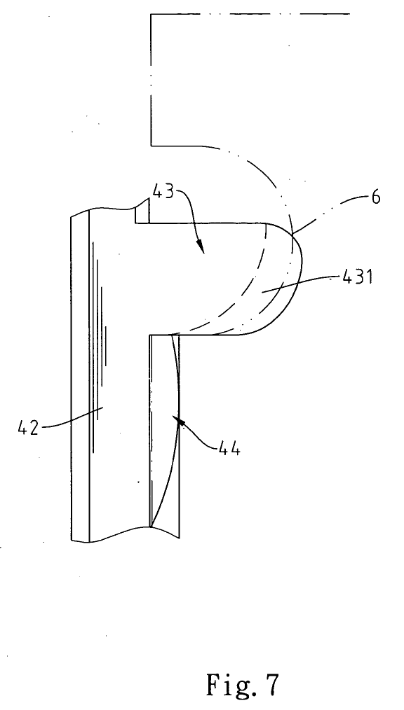

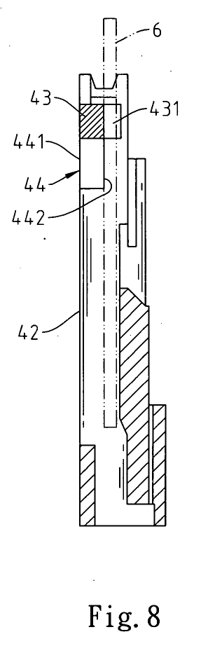

Please refer to the contents from FIG. 5 to FIG. 8. The present invention offers a card connector that mainly consists of an insulative body 4 and a multiple number of conductive terminals 5 in the insulative body 4.

The insulative body 4 contains a base 41 with a card slot 411 and two sticking elastic arms 42 symmetrically located at both sides of the base 41. The card slot 411 is located at one side of the base 41, while the multiple number of conductive terminals 5 are in the card slot 411 for insertion of an electronic card 6 and electric connection of the electronic card 6 and the conductive terminals 5.

Besides one bump 43 on the inner side 421 of the terminal of each elastic arm 42, there is an auxiliary bump 44. The bump 43 appears in a shape that the top is larger than the bottom and has a differentiated section 431. The auxiliary bump 44 has an opposite arrangement, which includes a top slope 441 and a bottom flat 442 to increase the connection contact area for the electronic card 6 and facilitate the positioning of the electronic card 6 while it is pressed down.

The auxiliary bump 44 can be independently formed on the inner side 421 of the elastic arm 42 and behind the bump 43, or situated behind the bump 43 to be integrated with the bump 43, as shown in figures from FIG. 5 to FIG. 8.

No matter what type of arrangement of the auxiliary bump 44, it only increases the connection contact area in the front and in the back, but not on the sides. Thus, the present invention not only provides increased connection contact area (i.e. increased flat 442 area) for an enhanced connection to secure the card in the slot but also facilitates the positioning of the electronic card 6 through easy passing of the sides of the inserted electronic card 6 by the auxiliary bump 44 with a top slope 441.

What the invention claimed is:

1. A card connector is composed of:
an insulative body consisting of a base with two sticking elastic arms at two sides of the base, one card slot on each side of the base, an inner side for each elastic arm, a bump and an auxiliary bump that is behind the bump on each inner side;
a multiple number of conductive terminals in the card slot.

2. As described in claim 1 for a card connector, the auxiliary bump contains a top slope and a bottom flat.

3. As described in claim 1 for a card connector, the auxiliary bump is independently formed on the inner side of the elastic arm.

4. As described in claim 1 for a card connector, further the auxiliary bump is behind the bump.

5. As described in claim 1 for a card connector, the auxiliary bump can be further integrated with the bump.

6. As described in claim 1 for a card connector, the bump has a differentiated section that the top is larger than the bottom.

7. As described in claim 1 for a card connector, the auxiliary bump is in a shape that the top is smaller than the bottom.

8. As described in claim 1 for a card connector, the auxiliary bump can further contain a top slope and a bottom flat.
